(19) United States
(12) Patent Application Publication
(10) Pub. No.: US 2015/0373928 A1
(43) Pub. Date: Dec. 31, 2015

(54) PLANT CONTAINMENT PANEL

(71) Applicant: Earl Senchuk, Marquette, MI (US)

(72) Inventor: Earl Senchuk, Marquette, MI (US)

(21) Appl. No.: 14/752,928

(22) Filed: Jun. 27, 2015

Related U.S. Application Data
(60) Provisional application No. 62/017,986, filed on Jun. 27, 2014.

(51) Int. Cl. A01G 13/00; A01G 9/24

(52) U.S. Cl. CPC A01G 13/0237; A01G 9/247

(57) ABSTRACT

A containment panel is disclosed configured to separate a portion of ground from another portion of the ground. The panels include a portion of the panel configured to be inserted into the ground comprising a retention feature and a portion of the panel configured to remain above the ground. The portion configured to remain above the ground includes a slanted portion configured to channel water toward plants contained by the panel.

### CROSS REFERENCE TO RELATED APPLICATIONS

This disclosure claims the benefit of U.S. Provisional Application No. 62/017,986, filed on Jun. 27, 2014, which is hereby incorporated by reference.

### FIELD OF THE DISCLOSURE

The present disclosure relates generally to a device that selectively contains water received by a plant or series of plants. In particular, examples of the present disclosure are related to a panel that is inserted into the ground next to a plant to create a partition, enabling the plant to utilize water it received without water being wasted on ground away from the plant.

### BACKGROUND

The statements in this section merely provide background information related to the present disclosure. Accordingly, such statements are not intended to constitute an admission of prior art.

Water is required for plants to grow. Sometimes, a plant grows in a region that receives an appropriate amount of rainfall, and the plant does not require watering by the person tending the plant. In other circumstances, a plant may be cultivated in an area that does not receive adequate rainfall to support the development of the plant, or weather variability including a time period with less than average rainfall can cause the plant to receive less than an optimal amount of water. However, water is a resource. In some locations, such as parts of California, water use is strictly regulated based upon scarcity and competing demands for available water.

### SUMMARY

A containment panel is disclosed configured to separate a portion of ground from another portion of the ground. The panels include a portion of the panel configured to be inserted into the ground comprising a retention feature and a portion of the panel configured to remain above the ground. The portion configured to remain above the ground includes a slanted portion configured to channel water toward plants contained by the panel.

### BRIEF DESCRIPTION OF THE DRAWINGS

One or more embodiments will now be described, by way of example, with reference to the accompanying drawings, in which:

FIG. 1A is a front on view of an exemplary containment panel, in accordance with the present disclosure; and

FIG. 1B is a side view of the containment panel of FIG. 1A, in accordance with the present disclosure;

FIG. 2A illustrates a tool creating of a trough in soil, in accordance with the present disclosure;

FIG. 2B illustrates insertion of a containment panel within the trough of FIG. 2A, in accordance with the present disclosure;

FIG. 3 is a drawing illustrating containment panels installed on either side of a plant, with the panels separating a portion of the ground around the plant from other portions of ground distant from the plant, in accordance with the present disclosure;

FIG. 4 is a drawing illustrating the containment panels and the plant of FIG. 3 after the plant has grown to maturity, in accordance with the present disclosure;

FIG. 5 illustrates a portion of ground surrounded by containment panel with segments of the panels including expandable sections permitting the panel to be bent around a corner, in accordance with the present disclosure;

FIG. 6 illustrates a process for creating troughs and subsequently installing a series of containment panels, for example, to contain a row of cultivated plants, in accordance with the present disclosure;

FIG. 7 illustrates an exemplary planter template or tray with depressions, trough, and V notch, in accordance with the present disclosure;

FIG. 8 illustrates features of a planter tray similar to the tray of FIG. 7, illustrating the features in cut-away cross section, in accordance with the present disclosure;

FIG. 9 illustrates in cross-section another exemplary embodiment of a planter tray, in accordance with the present disclosure;

FIG. 10 illustrates an alternative embodiment of a planter template including a seed plunger and a lift handle, in accordance with the present disclosure;

FIG. 11 illustrates an alternative embodiment for a containment panel including a single bend in the panel and a hole located below the ground, in accordance with the present disclosure; and

FIG. 12 illustrates an additional alternative embodiment for a containment panel including a straight panel and holes located both above and below the ground, in accordance with the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not illustrated in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale. Embodiments in accordance with the present disclosure may be embodied as an apparatus or process.

When cultivating plants, it is useful to take measures to allow the plants to receive an optimal amount of nutrients and water. Furthermore, it is useful to protect the plant's roots and to contain groups of plants together in the soil.

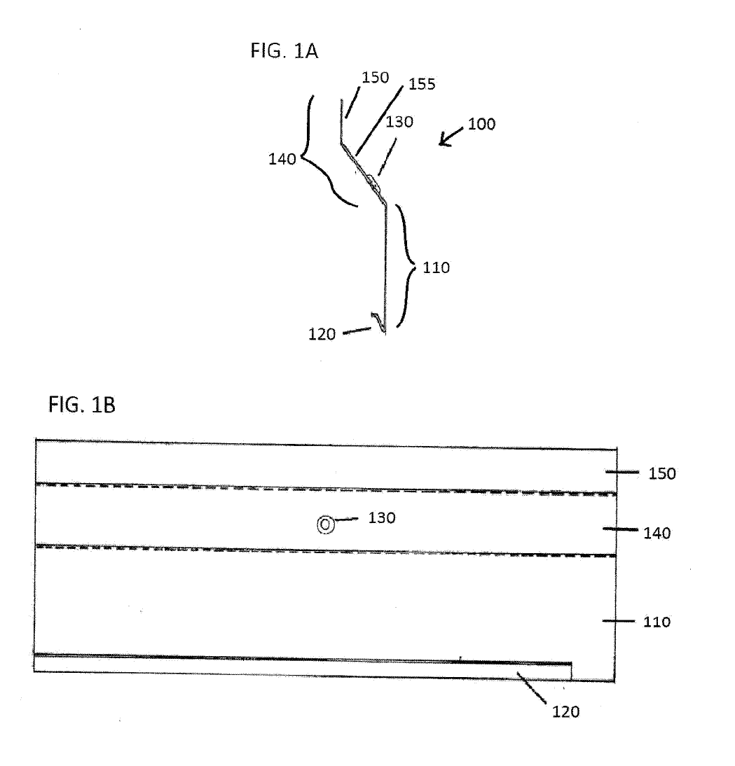

A device useful for planting and tending plants includes a moisture retaining soil liner. In one embodiment, the moisture retaining soil liner is a containment panel comprising a thin sheet length of recyclable material of planar construction, formed to have multiple longitudinal bends and curve, having a circular embossment with a hole, and with interlocking connectable means. The sheet can be described as a containment panel. FIGS. 1A and 1B illustrate an exemplary containment panel.

FIG. 1A shows an end view of the exemplary containment panel 100. A portion of the panel configured to be inserted into and to remain in the ground 110 includes at its bottom end a retention feature 120. The retention feature allows the containment panel to remain in place once it is inserted into the soil, and functions to resist extraction or movement by wind, weather, animals or other disturbances. In one embodiment, the retention feature is an extraction resistor flap. At the top end of the below-ground portion 110 is portion 140 of the panel, which is configured to remain above the ground when the containment panel is inserted into the ground. In some embodiments above-ground portion 140 is configured angularly to portion 110.

Above-ground portion 140 can include a first portion 155 configured to either be parallel or with a slight or small angle, for example, less than 45 degrees, with respect to the ground. Portion 155 with a small angle with respect to the ground is useful to increase the area which the panel system gathers falling water. Further, portion 155, being at a different angle from below-ground portion 110 prevents the panel from being inserted too far into the ground. Above-ground portion 140 can include a second portion 150 acting as a side shield for the plants, protecting the plant against winds and damage from a side. Above-ground portion 140 can include an embossment with a hole 130. The embossment prevents water rolling down the inside of the panel system from dripping through the hole but still permits pooled water within the panel system to drip out and prevent overwatering of the contained plant. In another exemplary embodiment, hole 130 can be simply punched through portion 140. In some embodiments, each containment panel features one hole. In other embodiments, each containment panel features multiple holes. In some examples, the holes are set in patterns depending on types of plants to be contained and amount of water a user wishes to have near the plants, among other considerations. In some embodiments, holes can be of various sizes and shapes depending on the needs of the plants. According to one embodiment, a pattern of holes can be created on the panel, for example with few small holes being located lower on the panel and with many larger holes located higher on the panel.

In some embodiments, for example for use in areas where water is particularly scarce, no holes are located on the panel, adjacent panels include features to seal to the next adjacent panel, and the panel system is water impermeable.

In some embodiments, at the top end of above-ground portion 140 is a portion of the panel which is also configured to remain above the ground in a configuration perpendicular to the plane of the soil. Side shield portion 150 aids in containing water and nutrients, and aids in sheltering a plant.

FIG. 1B shows a side view of the containment panel of FIG. 1A. The containment panel includes below-ground portion 110, above-ground portion 140, side shield portion 150, and retention feature 120. Additionally, hole 130 is illustrated in portion 140. In some embodiments, the panel can include an the interlocking feature such as a notch that fits into a receiving portion of another containment panel, enabling a plurality of panels to be connected end to end.

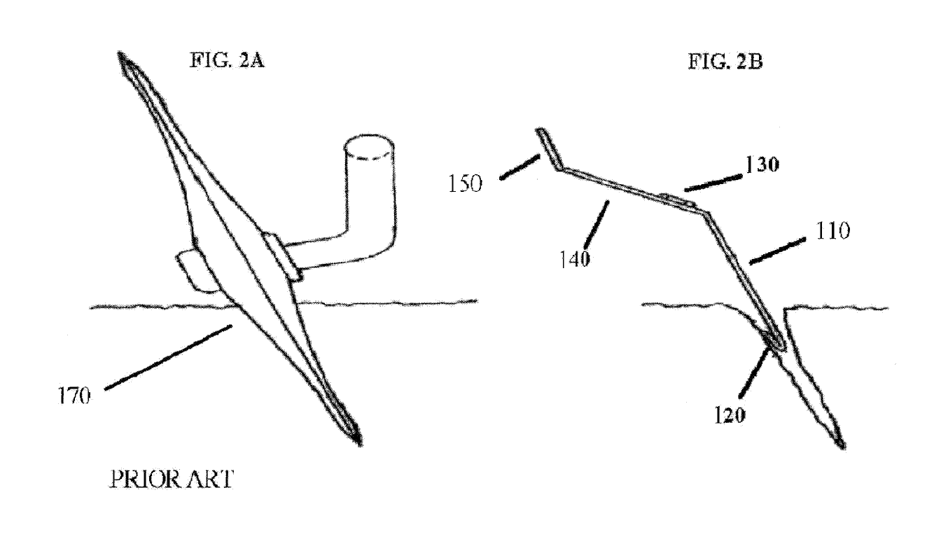

FIGS. 2A and 2B illustrate creation of a trough in the soil and subsequent insertion of a containment panel within the trough. To insert the containment panel into the ground where desired, a trough or deep cut is made angularly into the soil with a shovel or rolling circular blade 170. Below-ground portion 110, including retention feature 120, is inserted into the trough up to the point at which the below-ground portion 110 meets the above-ground portion 140. Hole 130 rests just above the ground level after insertion. Side shield 250 projects upward from the ground, protecting the plants from the sides and channeling falling water inward toward the plant.

Retention feature 120, once inserted into the soil, will resist being pulled out. In one embodiment, the retention feature is an extraction resistor flap which tends to flare out in the process of extraction, making it difficult to extract the containment panel from the ground. This feature will hold the containment panel in place during inclement weather, high winds and other disturbances. This process illustrated in FIG. 2B can be performed on one side of a plant or repeated in mirror image on the opposite side of a plant or plant row.

The disclosed containment panel system includes a number of purposes or benefits. A first purpose includes capturing rain more effectively than could occur naturally. A second purpose includes delivering rain and manually supplied water to the most preferred location, the plant's roots. A third purpose includes containing nutrients added to the soil so they benefit the preferred plant and not surrounding weeds or other plants. A fourth purpose includes conserving water by delivering 100% of watering efforts to the roots and only to the roots of the desired plants. Water can be stockpiled in plentiful times and limited to accurate dispensation sufficient to meet the sustainable need of the plants as a means to survive and thrive during periodic times of drought. A fifth purpose includes restricting water to competing weeds, thereby limiting the need to weed. A sixth purpose includes isolating the root system of the preferred plant so as to prevent it from intermingling with the roots of competing weeds. A seventh purpose includes limiting evaporation from the soil surface by means of containment of moisture laden air within the barrier created by the soil liner and bottom level of the foliage. An eighth purpose includes allowing excess water to be released out the overflow hole. A ninth purpose is to limit risk of soil erosion by wind by means of the barrier created by the above-ground portion of the containment panel.

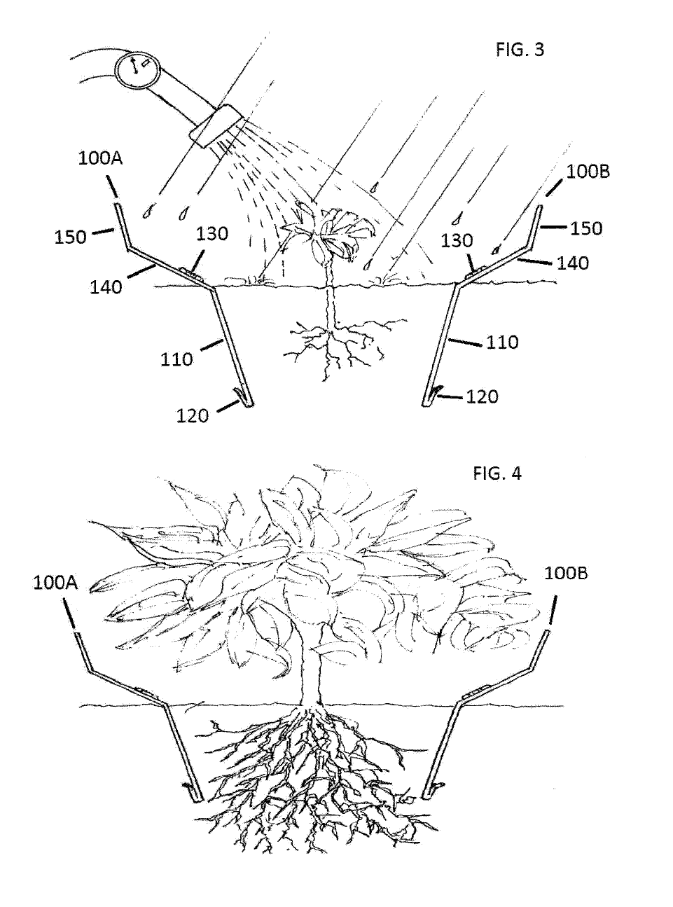

FIG. 3 illustrates containment panels 100A and 100B installed on either side of a plant, with the panels separating a portion of the ground around the plant from other portions of ground distant from the plant. In this configuration, water can be provided to the plant without the water being wasted on the ground away from the plant. Panels 100A and 100B are illustrated, each with below-ground portions 110, holes 130, and side shield portions 150. In one embodiment, the panels can be extended out away from the plant so that rain that would hit a wider area of ground will be channeled into the ground close to the plant. Holes 130 upon by the above-ground portions of panels 100A and 100B ensure that water will not pool around the plant and flood the plant out, thereby harming the plant.

The angled orientations of the panels in FIG. 3 are exemplary. In some embodiments, the panels can be oriented more vertically or at more of a slant, depending on the needs of the plant and the desires of the cultivator.

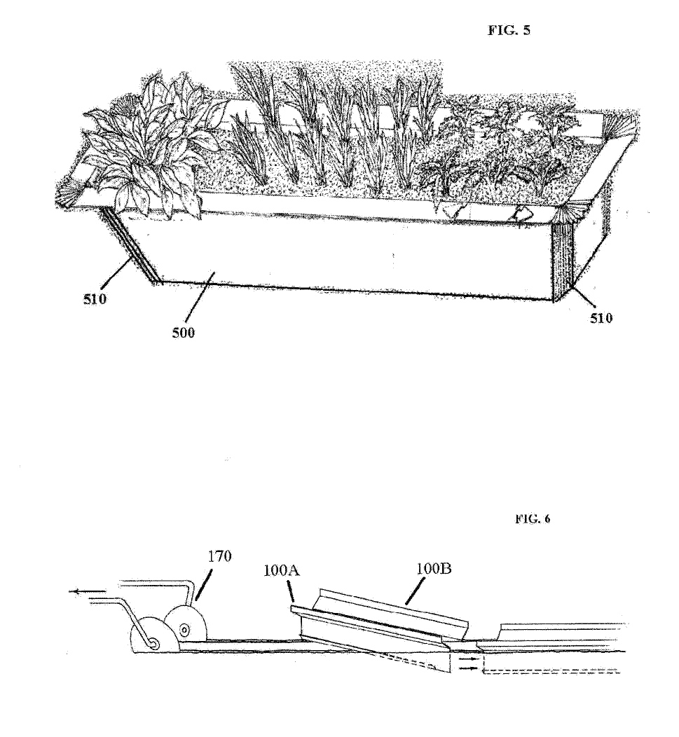

FIG. 4 illustrates the containment panels and the plant of FIG. 3 after the plant has grown to maturity. The panels 100A and 100B are ideally placed such that the root ball and the foliage of the plant are unimpeded by the panels but any portion of the ground not needed by the root ball is separated away from the portion of the ground near the plant and away from the water applied to the ground near the plant.

Containment panels may be attached by interlocking means to form an enclosed area. The system of containment panels can be extended to unlimited length to serve a commercial growing operation or limited to a section of a small garden plot by means of end caps with corrugations. One part serves corner or round applications, the other part serves running lengths between corners. Pieces intended for corners or rounds have corrugations to allow flexibility to bend.

FIG. 5 illustrates a portion of ground surrounded by containment panel 500 with segments of the panels including expandable sections 510 permitting the panel to be bent around a corner. Dirt that would be located around panel 500 is omitted from FIG. 5 for purposes of illustration. Attachment of multiple panels 500 or of one end of panel 500 to another end of panel 500 can be made by interlocking tabs or simply stapled or otherwise temporarily or permanently attached at the top lip or at another location. FIG. 5 demonstrates use in a small garden section wherein a single length of the panels is bent around the garden section and connected to itself to make an enclosed rectangular containment panel border. For purposes of clarity of illustration of expandable sections 510, holes similar to holes 130, side shields similar to shields 150, and retention features similar to retention features 120 are not illustrated upon panel 500, although any and all of those features can be fitted upon panel 500.

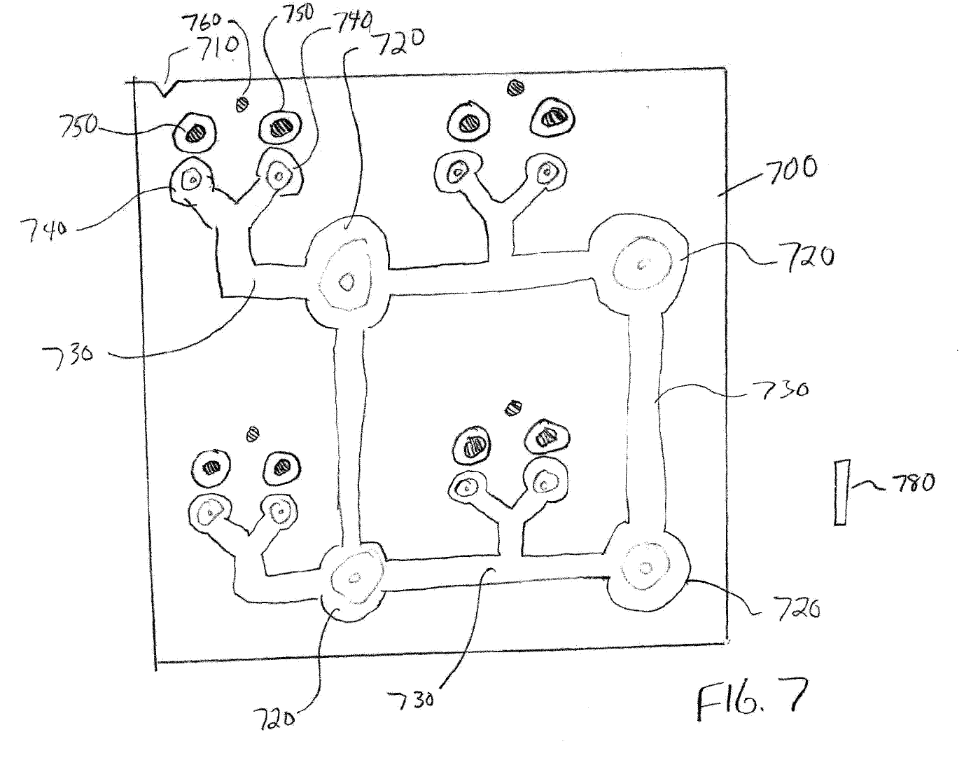

FIG. 6 illustrates a process for creating troughs and subsequently installing a series of containment panels, for example, to contain a row of cultivated plants. Such a process could be mechanized to permit containment of long rows of plants in a field and could include multiple rows at a time. Circular blades 170 can be pulled behind an exemplary tractor vehicle, and workers can follow the tractor and insert panels 100A and 100B into the troughs created by circular blades 170. In another embodiment, an automated trailer device can be attached to a tractor vehicle, the trailer device including one or multiple sets of circular blades 170, and long flexible sections of panels 100A and 100B can be created and formed into rollers, with the trailer device deploying the rollers of panels immediately after the blades 170 create troughs.

Containment panels can be retrievable prior to harvest if necessary to be recycled or reused. Containment panels can be made of multiple alternative materials including rubber, plastic, polymers, stamped metal such as aluminum, biodegradable recycled paper similar to egg cartons, or any other material or combination of materials known in the art. In one embodiment, the panels can be extruded, and holes can be drilled in the extruded panels for drainage according to embodiments of the disclosure. Containment panels can include individual panels, or containment panels can be provided on a large roll of flexible continuous material.

Plants in a garden require certain conditions to grow to a desired maturity and be fruitful. A plant has roots that form a root ball. As the roots grow, they tend to grow outward from the stem of the plant to a particular radius. Similarly, each species of plant has a foliage pattern that includes a particular radius that the branches or leaves tend to span out from the stem. If another plant is within either the radius of the root ball or the radius of the foliage pattern, the growth of the plant will be stunted. Each species of plant has a recommended spacing from other plants that should be observed to achieve best results for the development of the plant.

Similarly, a seed can have an optimal depth for planting. If a seed is planted too shallow, it can be eaten by a bird or other animal or be overheated or dried out by sunlight. If a seed is too deep, a sprout from the seed can fail to reach the surface or the seed can fail to receive a required amount of water.

A device useful for planting is a template device for arranging and accurately planting seeds in a patch of soil according to a desired spacing. The template can be specific to a particular plant. A first template can be provided for planting tomatoes and a second template can be provided for planting carrots.

In another embodiment, a first template with a first spacing pattern can be provided and a second template can be provided with a second spacing pattern. Such templates can depend upon the knowledge of the user to determine which template is appropriate for a particular species of plant. In another embodiment, the templates can have words, logos, colors or other indicators printed on the template to indicate that this template is best for these species of plants.

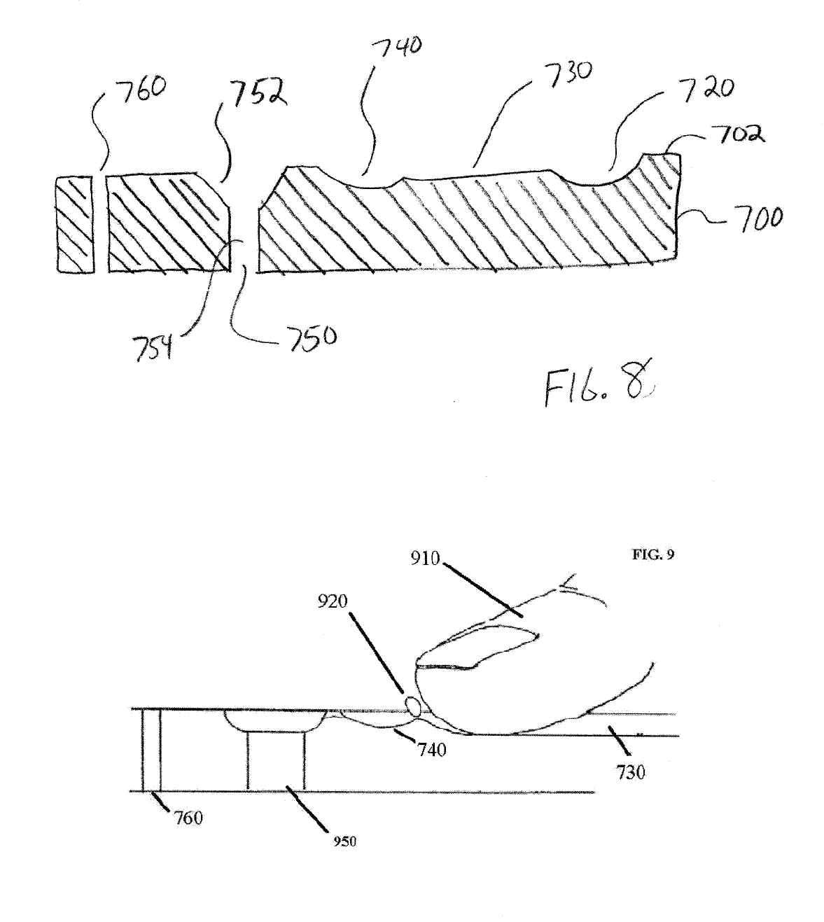

FIG. 7 illustrates an exemplary planter template with depressions, trough, and V notch. The disclosed device 700 can include a thin, flat sheet of material having holes of two different sizes that are drilled or otherwise formed in prescribed locations relating to shallow depressions of different depths and sizes, and a connecting trough 730. A V notch 710 in the upper left hand corner of the device, intended to be felt by a user's left hand index finger, ensures proper placement of the device, for example, making the device more useful to a blind user. According to an embodiment of the disclosure, seeds are dispensed from the package into the seed separator areas 720. A template can include a series of troughs 730 and seed preload areas 740 whereupon a user can separate and easily route individual seeds upon the surface of the template for easy deposit into a seed drop and tamp hole 750.

Marker pins 780 optionally be used with planter templates. Such pins 780 can be inserted through marker holes 760 and left in the soil after the planter tray is removed. In this way, one may accurately locate where the tray should be placed for a new set of seeds. Further, the pins can assist the user to pull weeds as the seeds germinate. Marker holes 760 can be located near to the drop and tamp holes 750. By only picking weeds that are not aligned with the marker pins 780, the user can avoid accidentally pulling seedlings with the weeds.

Planter tray 700 is easy to use and aids the user in planting the seeds at a proper distance from each other. Additionally, the depressions forming the separator areas 720, troughs 730, preload areas 740, and drop and tamp holes 750 are tactile features. Tray 700 can be used with blind or disabled persons, providing a tactile experience associated with planting. Seeds can be arranged by feel in the separator areas 720, troughs 730 aid to guide the seeds to the preload areas 740. A blind user can use marker pins to feel where the last seeds were planted and can use notch 710 to align the tray in a new location to plant more seeds.

FIG. 8 illustrates features of a planter tray similar to the tray of FIG. 7, illustrating the features in cut-away cross section. Tray 700 is illustrated including separator area 720, trough 730, preload area 740, drop and tamp hole 750, and marker hole 760. Tray 700 includes top surface 702 which forms an un-depressed surface of tray 700. Separator area 720, trough 730, and preload area 740 are formed as depressions lowered from surface 702 useful for guiding seeds around the tray. Hole 750 includes an exemplary countersunk feature 752 and straight section 754.

The trays of FIG. 7 and FIG. 8 can be made of any of a number of materials. Exemplary trays can be cut from a block of wood. In another example, a block tray can be formed of a polymer such as Plexiglas, and the holes and depressions can be either formed with the tray or machined in the polymer after initial formation. Other embodiments can be constructed of metals, rubber, cardboard, or other similar materials.

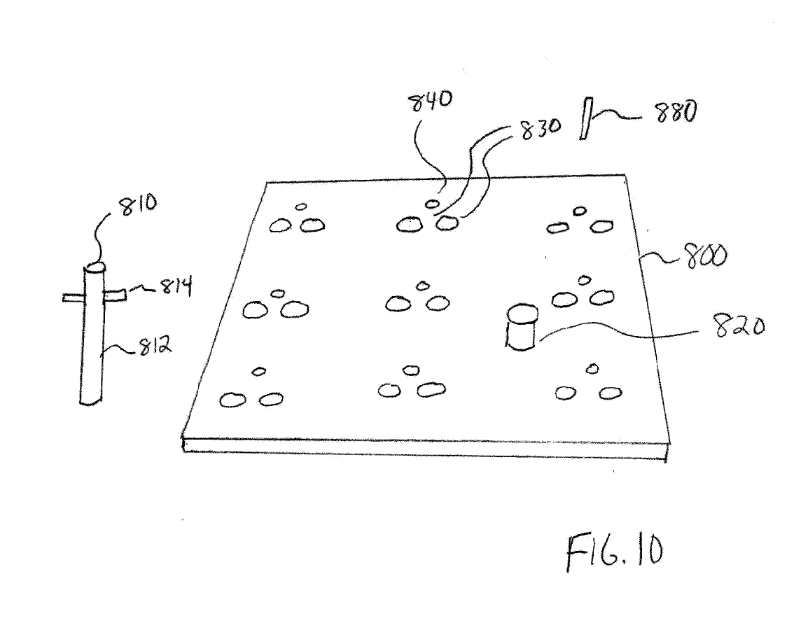

FIG. 9 illustrates in cross-section another exemplary embodiment of a planter tray. The illustrated tray includes trough 730, preload area 740, marker hole 760, and drop and tamp hole 950 including a bowl shaped receiving section. User's finger 910 is illustrated pushing seed 920 from trough 730 into preload area 740.

FIG. 10 illustrates an alternative embodiment of a planter template including a seed plunger 810 and lift handle 820. Tray 800 is illustrated including an exemplary thin tray constructed of exemplary injection molded plastic with approximately equal cross sectional thickness throughout. Drop and tamp holes 830 are provided in pairs across the tray. The holes 830 match in size to a diameter of lower section 812 of seed plunger 810. Plunger 810 additionally includes widened section 814 which, by being stopped upon a top surface of tray 800 as the plunger 810 is inserted within one of holes 830, aids the user in tamping the seeds to the correct depth defined by the length of section 812. Marker holes 840 can be used according to the disclosure to place marker pins 880 with the seeds. A handle 820 for vertical lifting of the template can be included.

In another embodiment, a plunger device or a plurality of plunger devices can be supplied with a template to permit a user to set a seed within a particular hole in the template and then use the plunger to depress the seed into the surrounding soil. A stopper feature on the plunger can cause the plunger to only be inserted and depress the seed to a desired depth. Plungers can be labeled or indicated for particular plant species or indicated for a particular depth.

When all of the seeds have been plunged and the locations marked with small dowels on the template, a user can lift the template straight up leaving the marker pins.

The disclosed template system includes a number of purposes or benefits. A first is to ensure the proper and ideal seeding locations for a given plant species based upon root ball or ultimate spread of foliage. A second is to ensure proper depth of seed insertion for any given plant. A third is to eliminate or reduce a chance for double seeding. A fourth is to cover for seeds that fail to thrive. A fifth is to make seeding simpler, easier, and faster, with better results. A sixth is to work in conjunction with a Square Foot Gardening method, a method that seeks to optimize a number of thriving plants per square foot. A seventh is to reduce accidental spillage of seeds. An eighth is to dramatically reduce weeding time. A ninth is to ensure proper placement by means of a notch in the upper left hand corner. A tenth is to enable the handicapped to enjoy gardening. For example, a person with arthritis can separate and move the seeds with any finger without having to pick up any seeds. Also, blind persons know how to properly hold the template by means of the V notch. Blind persons know where the plants are expected to grow and can learn the preferred plants by common feel near the markers.

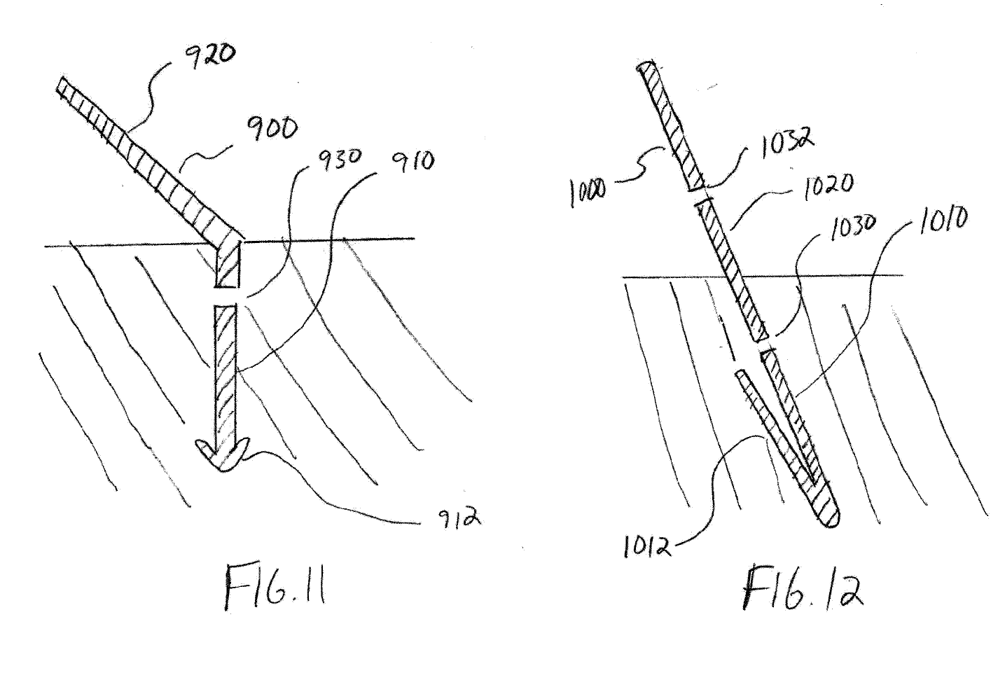

FIG. 11 illustrates an alternative embodiment for a containment panel. Panel 900 is illustrated including a below-ground portion 910 and an above-ground portion 920. Hole 930, illustrated without an embossment, is located on the below-ground portion 910. Such a hole located below the ground level can be used with plants that are particularly sensitive to overwatering or root damage caused by pooled water. Below-ground portion 910 is illustrated extending straight down-ward into the ground and includes a double sided retention feature 912. Above-ground portion 920 is canted to one side to capture increased water and channel the water toward a plant located to the right of the illustrated panel.

FIG. 12 illustrates an additional alternative embodiment for a containment panel. Panel 1000 is illustrated including a below-ground portion 1010 and an above-ground portion 1020. Hole 1030 is located on the below-ground portion 1010. A second hole 1032 is illustrated upon above ground portion 1020. In one embodiment, hole 1032 can be a relatively large hole, for example, 1 to 5 mm in diameter, permitting water pooling above ground to quickly drain past the panel. Hole 1030 can be relatively small, for example, less than 1 mm in diameter, retaining much water in the soil to the right of the illustrated panel but slowly permitting pooled water to drain past the panel to avoid long term damage to the roots of contained plants. An enlarged retention feature 1012 is illustrated, including a length over half the length of the under-ground portion 1010. Panel 1000 is illustrated as a straight panel, with above-ground portion 1020 and below ground portion 1010 being in-line with each other.

The planter trays of FIGS. 7 and/or 10 can be used with the containment panel of FIG. 1 or elsewhere in the disclosure. One may set up an area at least the size of the planter tray within a containment panel system, and the tray can be used once of a plurality of times to situate and deposit seeds within the soil contained within the containment panel system.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A containment panel configured to separate a portion of ground from another portion of the ground, the panels comprising:
a portion of the panel configured to be inserted into the ground comprising a retention feature; and
a portion of the panel configured to remain above the ground and comprising a slanted portion configured to channel water toward plants contained by the panel.

2. The containment panel of claim 1, wherein the panel is water impermeable.

3. The containment panel of claim 1, further comprising a hole on the panel configured to permit water to drain past the panel.

4. The containment panel of claim 3, wherein the hole is surrounded by an embossment configured to prevent water dripping down the panel from passing through the hole while permitting pooled water to drain past the panel.

5. The containment panel of claim 3, wherein the hole is located on the portion configured to remain above the ground.

6. The containment panel of claim 3, wherein the hole is located on the portion configured to be inserted into the ground.

7. The containment panel of claim 6, further comprising a second hole located on the portion configured to remain above the ground.

8. The containment panel of claim 7, wherein the hole located on the portion configured to remain above the ground includes a larger diameter than the hole is located on the portion configured to be inserted into the ground.

9. The containment panel of claim 1, wherein the panel has an interlocking feature configured to permit the panel to be connected to a second adjacent panel.

10. The containment panel of claim 1, wherein the retention feature is an extraction resistor flap.

11. The containment panel of claim 1, wherein the panel has a flexible expandable portion which allows flexion around corners.

12. The containment panel of claim 1, wherein the portion of the panel configured to remain above the ground includes a pattern of holes.

13. The containment panel of claim 1, wherein the portion of the panel configured to be inserted into the ground is configured to be inserted at a slant.

14. The containment panel of claim 13, wherein the portion of the panel configured to remain above the ground comprises a slanted side shield portion configured to collect water and channel the water laterally toward plants contained by the panel.

15. The containment panel of claim 14, wherein the portion of the panel configured to remain above the ground further comprises a portion configured to remain substantially parallel to the ground.

16. The containment panel of claim 1, wherein the portion of the panel configured to remain above the ground comprises a slanted side shield portion configured to collect water and channel the water laterally toward plants contained by the panel.

17. A containment panel configured to separate a portion of ground from another portion of the ground, the panels comprising:
a portion of the panel configured to be inserted into the ground in a slanted orientation and comprising a retention feature; and
a portion of the panel configured to remain above the ground and to channel water toward plants contained by the panel and comprising:
a slanted side shield portion configured to collect water and channel the water laterally toward plants contained by the panel;
a portion configured to have a small angle with respect to the ground located between the portion configured to be inserted into the ground and the slanted side shield portion; and
holes configured to permit water to drain past the panel.
